(19) United States
(12) Patent Application Publication
(10) Pub. No.: US 2006/0017669 A1
(43) Pub. Date: Jan. 26, 2006

(54) Method and apparatus for uniformity and brightness correction in an OLED display

(75) Inventors: Ronald S. Cok, Rochester, NY (US); James H. Ford, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/894,729

(22) Filed: Jul. 20, 2004

(51) Int. Cl. G09G 3/30

(52) U.S. Cl. 345/77

(57) ABSTRACT

A system for the correction of brightness and uniformity variations in OLED displays is described, comprising: a) an OLED display including a plurality of light-emitting elements; b) a non-volatile memory having uniformity correction information for the OLED display stored therein and permanently associated with and physically attached to the OLED display; and c) a controller connected to the OLED display and to the non-volatile memory for reading the information from the non-volatile memory, receiving an input signal, correcting the input signal using the information to form a corrected input signal, and transmitting the corrected input signal to the OLED display. Also described are OLED display device units comprising an OLED display and a permanently associated non-volatile memory, and a method for the correction of brightness and uniformity variations in OLED displays.

### FIELD OF THE INVENTION

The present invention relates to OLED displays having a plurality of light-emitting elements and, more particularly, correcting for non-uniformities in the display.

### BACKGROUND OF THE INVENTION

Organic Light Emitting Diodes (OLEDs) have been known for some years and have been recently used in commercial display devices. Such devices employ both active-matrix and passive-matrix control schemes and can employ a plurality of pixels (each comprising one or more light-emitting elements). The pixels are typically arranged in two-dimensional arrays with a row and a column address for each pixel and having a data value associated with the pixel value. However, such displays suffer from a variety of defects that limit the quality of the displays. In particular, OLED displays suffer from non-uniformities in the pixels. These non-uniformities can be attributed to both the light emitting materials in the display and, for active-matrix displays, to variability in the thin-film transistors used to drive the light emitting elements.

A variety of schemes have been proposed to correct for non-uniformities in displays by using a display controller. For example, WO2004023446 A1 entitled “Electroluminescent Display Devices” by Knapp et al published 20040318 describes an active matrix electroluminescent display device having a signal processor to control the signals sent to the electroluminescent display device to reduce the non-uniformity in the display. Typically such schemes utilize some sort of calibration step to measure the non-uniformity in a display and the information from the measurement is stored in the display controller and used to correct an input signal. The corrected input signal is then applied to the display. Referring to FIG. 3, a controller 22 controls a display 10 and includes a correction circuit 30. An input signal 32 is corrected by the controller 30 to create a corrected input signal 34 that is provided to the display 10.

Other examples of such correction schemes include U.S. Pat. No. 6,081,073 entitled “Matrix Display with Matched Solid-State Pixels” by Salam granted Jun. 7, 2000, U.S. Pat. No. 6,414,661 B1 entitled “Method and apparatus for calibrating display devices and automatically compensating for loss in their efficiency over time” by Shen et al issued 20020702, U.S. Pat. No. 6,473,065 B1 entitled “Methods of improving display uniformity of organic light emitting displays by calibrating individual pixel” by Fan issued 20021029, and US20020030647 entitled “Uniform Active Matrix OLED Displays” by Hack et al published 20020314. These designs, however, require that the controller 22 having the correction information supplied within the correction circuit 30 must be permanently associated with the corresponding display. If the display 10 is calibrated at the time of manufacture, the display 10 must be sold with the controller 22 containing the calibration and any associated correction information. This is problematic because a controller is typically manufactured as part of an appliance and is not associated with a display until final assembly. Alternatively, the display may be calibrated and a controller loaded with calibration and correction information after an appliance is assembled. This is even more problematic in that the calibration must now be done by the assembler or purchaser.

An alternative means for providing uniformity correction is the so-called “system-on-glass”. In this alternative, processing circuitry is provided on the same substrate as the display. See for example, US20030025127 A1 entitled “Thin-Film Transistor Device and Method of Manufacturing the Same” published 20030206. Similarly, U.S. Pat. No. 6,501,230 entitled “Display with Aging Correction Circuit” by Feldman issued 20021231 describes a circuit integrated on the glass substrate of a display. However, it is difficult to manufacture high-performance or complex processing circuitry on a glass substrate using thin-film circuitry. Such an approach reduces manufacturing yields and increases the cost of display panels.

There is a need, therefore, for an improved system and method of providing uniformity correction in an OLED display that overcomes these objections.

### SUMMARY OF THE INVENTION

In accordance with one embodiment, the invention is directed towards a system for the correction of brightness and uniformity variations in OLED displays, comprising:

a) an OLED display including a plurality of light-emitting elements;

b) a non-volatile memory having uniformity correction information for the OLED display stored therein and permanently associated with and physically attached to the OLED display; and

c) a controller connected to the OLED display and to the non-volatile memory for reading the information from the non-volatile memory, receiving an input signal, correcting the input signal using the information to form a corrected input signal, and transmitting the corrected input signal to the OLED display.

In accordance with further embodiments, the invention is directed towards an OLED display device comprising an OLED display and a permanently associated non-volatile memory, and a method for the correction of brightness and uniformity variations in OLED displays.

### ADVANTAGES

The present invention has the advantage of providing improved uniformity, reduced manufacturing costs, and increased flexibility of use in an OLED display.

### BRIEF DESCRIPTION OF THE DRAWINGS

FIG. 1 is a perspective view of an embodiment of the present invention;

FIG. 2 is a schematic diagram of an embodiment of the present invention;

FIG. 3 is a prior art illustration of a uniformity compensation design;

FIG. 4 is a flow graph illustrating the method of the present invention; and

FIGS. 5a and 5b are photographs of an OLED device with and without uniformity correction according to the present invention.

### DETAILED DESCRIPTION OF THE INVENTION

The present invention is directed to a system for the correction of brightness and uniformity variations in OLED displays, comprising an OLED display having a plurality of light-emitting elements; a non-volatile memory having uniformity correction information stored therein and permanently associated with and physically attached to the OLED display; and a controller connected to the OLED display and to the non-volatile memory for reading the information from the non-volatile memory, receiving an input signal, correcting the input signal using the information to form a corrected input signal, and transmitting the corrected input signal to the OLED display. In accordance with one embodiment, the OLED display may comprise a substrate where the plurality of light-emitting elements are formed on the substrate and are electrically connected through electrodes located on the substrate, and the non-volatile memory may be formed on a separate substrate. Alternatively, the non-volatile memory may be formed on the same substrate. Forming the non-volatile memory on a separate substrate advantageously improves yields, reduces costs, and reduces the physical size of the display. Use of a common substrate, on the other hand, reduces the number of components. The common substrate design is further advantaged over prior “system-on-glass” designs including processing circuitry provided on the same substrate as the display, in that the non-volatile memory circuitry of the present invention is smaller and less complex.

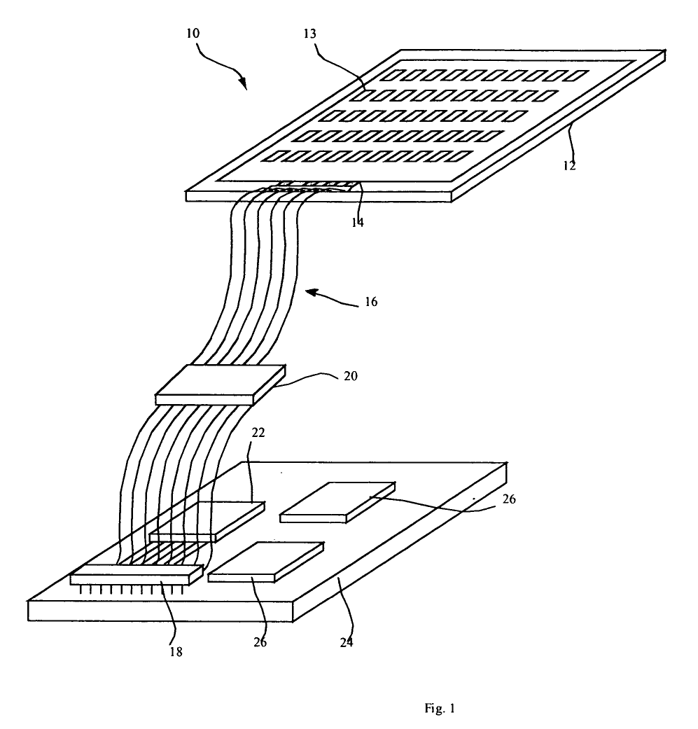

Referring to FIG. 1, an OLED display 10 having a substrate 12 and a plurality of light-emitting elements 13 electrically connected through electrodes 14 located on the substrate 12. A non-volatile memory 20 is formed on a separate substrate having uniformity correction information stored therein and permanently associated with and physically attached to the OLED display 10; and a controller 22 connected to the OLED display 10 and to the non-volatile memory 20 for reading the information from the non-volatile memory 20, receiving an input signal, correcting the input signal using the information to form a corrected input signal, and transmitting the corrected input signal to the OLED display 10. The electrodes 14 are connected to an integrated circuit comprising the non-volatile memory device 20 through a signal cable 16 permanently affixed (e.g., by soldering) to the substrate 12. The cable 16 is further connected through an external printed circuit board 24 to a controller 22. The cable may be a conventional flexible wiring cable carrying one or more electrical wires for conducting signals to and from the OLED display 10, the non-volatile memory 20, and the controller 22. Means for affixing and connecting the non-volatile memory 20 to the flexible wiring cable 16 are well-known in the electronics manufacturing art (e.g., adhesives) as are means to connect the flexible wiring cable 16 to the printed circuit board 24 (e.g., socket connectors) and OLED display 10 (e.g., by soldering). The printed circuit board 24 may include additional electronic components 26 as may be useful in an application.

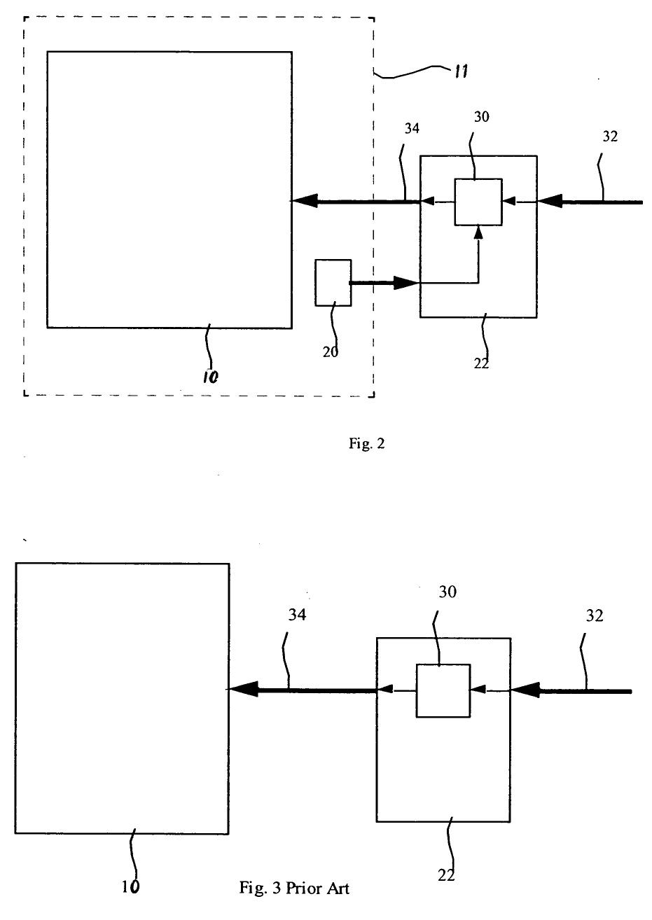

Referring to FIG. 2, the OLED display 10 and non-volatile memory 20 are associated and packaged as an OLED display device unit 11. The non-volatile memory 20 may be physically affixed to a connecting cable, as shown in FIG. 1, or alternatively formed on a common substrate of the OLED display. Other means of permanently associating the non-volatile memory 20 to the OLED display may be employed, for example by affixing the memory 20 to the substrate 12 or a cover of the OLED display (not shown). The controller 22 is removably connected to the non-volatile memory 20 and includes signal and control circuitry for reading information from the non-volatile memory 20. As understood in the electrical arts, a non-volatile memory is a memory whose stored information is not lost when power is removed from the memory. The non-volatile memory 20 may be a Read-Only Memory (ROM), such as a programmable read only memory (PROM), including one-time programmable electrically programmable read only memory (OTP EPROM), and an electrically erasable programmable read only memory (EEPROM), that can be used to both read and write non-volatile information. Signals and control for such memory devices are very well known in the electronics industry. The controller 22 also includes circuitry for accepting an input signal 32 and correcting the input signal 32 using a correction circuit 30 to form a corrected input signal 34 that is supplied to the OLED display 10.

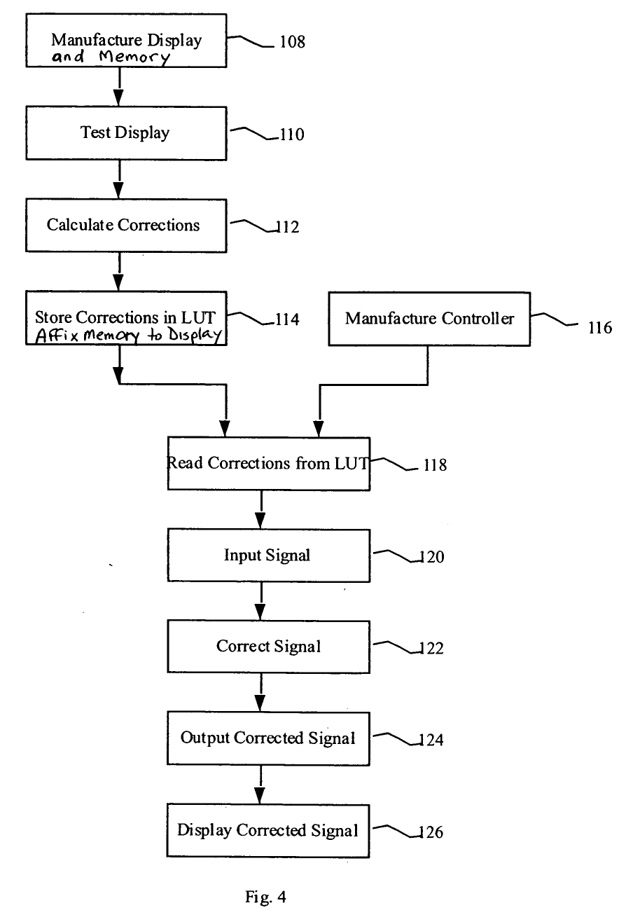

Referring to FIG. 4, an OLED display 10 and non-volatile memory 20 are first manufactured 108 using methods known in the OLED industry. Because of variability in the manufacturing process, the OLED display 10 is likely to include non-uniform light-emitting elements 13. The display is tested 110 by measuring the light output and uniformity of the display 10 and the measurements are used to calculate 112 corrections to reduce the non-uniformity of the OLED display 10. These corrections can be stored 114 in a look-up table in the non-volatile memory 20, and the memory can be permanently associated with and affixed to the display. A controller 22 for the OLED display 10 may be independently manufactured 116.

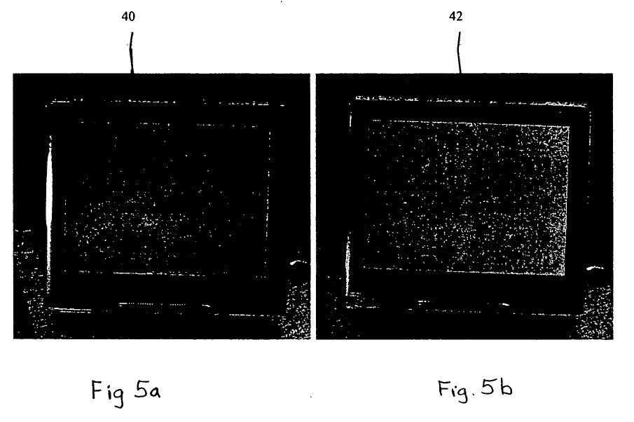

The OLED display 10;and permanently associated non-volatile memory 20 may then be sold as a display device unit 11. The purchaser may also separately purchase a controller 22. The display 10, memory 20, and controller 22 are integrated into a product. In operation, the controller 22 reads 118 information from the non-volatile memory 20. The information from the memory 20 is used to provide correction values to a correction circuit 30. An input signal 32 is input 120 to the controller 22. The correction circuitry 30 corrects 122 the input signal 32 using the information supplied from the non-volatile memory 20 to form a corrected input signal 34 that is transmitted 124 to the OLED display 10 and displayed 126. Referring to FIGS. 5a and 5b, e.g., an OLED display having non-uniform light-emitting elements is shown with a flat field before uniformity correction 40 (FIG. 5a) and after luminance uniformity correction is applied 42 (FIG. 5b).

The information stored in the non-volatile memory 20 may include a record of the light output from each, light-emitting element of each pixel of the OLED display. It may also include brightness information for the OLED display as a-whole and include an identifier for the OLED display 10 and associated memory 20 assembly. Additional information may be included in the non-volatile memory 20, for example size, type, aging characteristics, resolution, color, pixel patterns, materials, control signal, and display type information. As is known in the art, OLED devices also tend to age and decrease their light output over time as the OLEDs are used. In a further embodiment, the non-volatile memory is a read/write memory (e.g., an EEPROM), and the controller 22 writes information back to the non-volatile memory 20, for example a record of OLED display use. This record of use may also be used by the controller 22 to provide aging compensation in the correction circuitry 30. In yet another embodiment, the non-volatile memory 20 is included in an integrated circuit that also performs signal processing on the corrected input signal 34 before it is transmitted to the OLED display 10.

Certain embodiments of the present invention have an advantage in that the OLED display 10 and associated non-volatile memory 20 are manufactured separately and with relatively improved yields. Moreover, the memory 20 is very simple and low-cost, especially in comparison to the OLED display 10. The integration of the non-volatile memory 20 and OLED display 10 is a straightforward and low-cost manufacturing task.

The controller 22 is a relatively intelligent controller and, as is common practice, may be formed in a separate integrated circuit. Such circuits are well known and the correction circuitry incorporated into the controller may rely upon conventional integrated circuit manufacturing technologies. The OLED display and non-volatile memory unit 11 may be replaced with a different unit 11 if the first unit is no longer adequate. Hence, the present invention allows devices to be upgraded over time without regard to the characteristics of the OLED display. An intelligent controller such as that described will simply read new information from the non-volatile memory 20 and adapt the correction circuit to the new information. This adaptation may include uniformity correction, aging compensation, image rendering for alternative display resolutions, graphic rendering techniques, and many other image correction operations, for example color correction.

A variety of techniques for measuring the uniformity of an OLED display are known in the art which may be employed to provide the uniformity correction information stored on the non-volatile memory in the system of the invention. U.S. Pat. No. 6,414,661 B1, e.g., describes measuring the display characteristics of all organic-light-emitting-elements of a display, and obtaining calibration parameters for each organic-light-emitting-element from the measured display characteristics of the corresponding Organic-light-emitting-element. The described technique acquires information about each pixel in turn using a photo-detector. An additional technique for measuring uniformity which may be employed to provide the uniformity correction information stored on the non-volatile memory in the system of the invention is described in copending, commonly assigned U.S. Ser. No. 10/858,260, filed Jun. 1, 2004, the disclosure of which is incorporated by reference herein. Correction circuitry 30 may be implemented in a variety of conventional ways known in the art. An additional correction circuitry technique which may be employed in the system of the present invention is described in copending, commonly assigned U.S. Ser. No. 10/869,009, filed Jun. 16, 2004, the disclosure of which is incorporated by reference herein.

The invention has been described in detail with particular reference to certain preferred embodiments thereof, but it will be understood that variations and modifications can be effected within the spirit and scope of the invention.

### PARTS LIST

10 OLED display
11 OLED display device unit
12 substrate
13 light-emitting element
14 electrode
16 cable
18 connector
20 non-volatile memory
22 controller
24 printed circuit board
26 integrated circuits
30 correction circuitry
32 input signal
34 corrected input signal
40 uncorrected OLED display
42 corrected OLED display
108 manufacture display step
110 test display step
112 calculate correction step
114 store correction step
116 manufacture controller step
118 read corrections step
120 input signal step
122 correct signal step
124 output corrected signal step
126 display corrected signal step

What is claimed is:

1. A system for the correction of brightness and uniformity variations in OLED displays, comprising:
a) an OLED display including a plurality of light-emitting elements;
b) a non-volatile memory having uniformity correction information for the OLED display stored therein and permanently associated with and physically attached to the OLED display; and
c) a controller connected to the OLED display and to the non-volatile memory for reading the information from the non-volatile memory, receiving an input signal, correcting the input signal using the information to form a corrected input signal, and transmitting the corrected input signal to the OLED display.

2. The system of claim 1 wherein the OLED display comprises a substrate and the plurality of light-emitting elements are formed on the substrate and electrically connected through electrodes located on the substrate, and the non-volatile memory is formed on a separate substrate.

3. The system of claim 2 further comprising a cable having electrical conductors located therein for transmitting the corrected input signal from the controller to the OLED display, and wherein the non-volatile memory is affixed to the cable.

4. The system of claim 3 further wherein the cable is a flexible cable.

5. The system of claim 2 wherein the non-volatile memory is affixed to the substrate or a cover of the OLED display.

6. The system of claim 1 wherein one or more of the OLED display uniformity, brightness, aging characteristics, identification, color, resolution, pixel patterns, materials, control signal, or display type information is stored in the non-volatile memory.

7. The system of claim 1 wherein the non-volatile memory is a read only memory (ROM).

8. The system of claim 1 wherein the non-volatile memory is a programmable read only memory (PROM).

9. The system of claim 1 wherein the non-volatile memory is a read/write memory and wherein the controller writes information into the non-volatile memory.

10. The system of claim 9 wherein information written into the non-volatile memory includes usage information for the OLED display.

11. The system of claim 1 wherein the controller performs one or more of uniformity correction, aging compensation, image rendering for alternative display resolutions, graphic rendering techniques, and color correction.

12. The system of claim 1 wherein the non-volatile memory is included in an integrated circuit that performs signal processing on the corrected input signal before transmitting the processed corrected input signal to the OLED display.

13. The system of claim 1 wherein the non-volatile memory is a one-time programmable electrically programmable read only memory (OTP EPROM).

14. The system of claim 1 wherein the OLED display comprises a substrate and the plurality of light-emitting elements are formed on the substrate and electrically connected through electrodes located on the substrate, and the non-volatile memory is formed on the same substrate.

15. An OLED display device, comprising:
a) an OLED display including a plurality of light-emitting elements; and
b) a non-volatile memory having uniformity correction information for the plurality of light-emitting elements of the OLED display stored therein and permanently associated with and physically attached to the OLED display.

16. The device of claim 15 wherein the OLED display comprises a substrate and the plurality of light-emitting elements are formed on the substrate and electrically connected through electrodes located on the substrate, and the non-volatile memory is formed on a separate substrate.

17. The device of claim 16 further comprising a cable having electrical conductors located therein, and wherein the non-volatile memory is affixed to the cable.

18. The device of claim 17 further wherein the cable is a flexible cable.

19. The device of claim 16 wherein the non-volatile memory is affixed to the substrate or a cover of the OLED display.

20. The device of claim 15 wherein one or more of the OLED display uniformity, brightness, aging characteristics, identification, color, resolution, pixel patterns, materials, control signal, or display type information is stored in the non-volatile memory.

21. The device of claim 15 wherein the non-volatile memory is a read only memory (ROM).

22. The device of claim 15 wherein the non-volatile memory is a programmable read only memory (PROM).

23. The device of claim 15 wherein the non-volatile memory is a read/write memory.

24. The device of claim 23 wherein information written into the non-volatile memory includes usage information for the OLED display.

25. The device of claim 15 wherein the non-volatile memory is a one-time programmable electrically programmable read only memory (OTP EPROM).

26. The device of claim 15 wherein the OLED display comprises a substrate and the plurality of light-emitting elements are formed on the substrate and electrically connected through electrodes located on the substrate, and the non-volatile memory is formed on the same substrate.

27. A method for the correction of brightness and uniformity variations in OLED displays, comprising:
a) providing an OLED display having a plurality of light-emitting elements;
b) providing a non-volatile memory in association with the OLED display;
c) storing OLED display attribute information into the non-volatile memory;
d) permanently associating and physically attaching the non-volatile memory to. the OLED display;
e) reading the OLED display attribute information from the non-volatile memory into a controller;
f) correcting an input signal using the OLED display attribute information to produce a corrected input signal; and
g) displaying the corrected input signal on the OLED display.

28. The method of claim 27 further comprising the step of writing usage information for the OLED display into the non-volatile memory.
